(19) United States
(12) Patent Application Publication
(10) Pub. No.: US 2012/0185667 A1
(43) Pub. Date: Jul. 19, 2012

(54) VIRTUAL-MEMORY SYSTEM WITH VARIABLE-SIZED PAGES

(76) Inventor: Kamlesh Gandhi, Andhra Pradesh (IN)

(21) Appl. No.: 13/498,098

(22) PCT Filed: Sep. 22, 2010
(86) PCT No.: PCT/IN2010/000641

§ 371 Date: Mar. 23, 2012

(30) Foreign Application Priority Data
Sep. 25, 2009 (IN) 2020/CHE/2009

(51) Int. Cl. G06F 12/08

(52) U.S. Cl. 711/203; 711/E12.016

(57) ABSTRACT

A method for managing a virtual memory system configured to allow variable-sized pages is provided. The size of a page is not required to be a power of two. Variable, arbitrarily-sized pages are mapped to a contiguous segment or virtual address space. The method also provides for efficient relocation, insertion, and removal of data in a virtual memory region. The method also provides virtual lookup-tables.

### FIELD OF INVENTION

The invention relates to memory management on computers and other electronic devices. More particularly, it relates to the mapping of variable sized pages in virtual memory systems. It also relates to computers wherein variable-sized pages could be mapped in virtual memory systems.

### BACKGROUND OF THE INVENTION—DESCRIPTION OF PRIOR ART

Virtual memory systems are widely used in modern computers and other electronic devices. A virtual memory system allows programs to access data using virtual addresses in one or more virtual memory-regions.

A memory management unit (MMU) in the virtual memory system translates an address in an address space to an address in another address space. For the purposes of an MMU, the first address space is called the virtual address space, and the second address space is called the physical address space. An address in the virtual-address space is called a virtual address, and an address in the physical address space is called a physical address. In some cases, a physical address must be further translated to derive a usable address.

The MMU comprises a lookup-table, in the form of a translation lookaside buffer, a page table, an inverted page-table, a hash-table, or the like, to associate a range of addresses in the virtual address space with a page-table-entry. Many MMUs use a translation lookaside buffer and a page-table in combination. A page-table-entry comprises a translation-descriptor, also known as a page-descriptor. The page-descriptor field associates the page-table-entry with a number of addresses in the physical address space. In conventional systems, the physical address space is divided into pages of predetermined fixed sizes. Each page-descriptor field holds the address of a page in physical address space. Usually, the lower bits in the page-descriptor are truncated.

During address translation, the virtual address is split into a page-number and a page-offset. The MMU locates a page-table-entry associated with the page-number. The address of the page in the page-descriptor field in the page-table-entry is concatenated with the page-offset part of the virtual address to arrive at the physical address.

A page-table-entry also comprises a number of access-control and protection fields, such as write-only field, read-only field, and execute field, for providing access-control and protection over the page mapped by the page-table-entry.

A page may be located, from time to time, in primary storage or in secondary storage. A page-database, page-frame-database, or core-map, in the virtual memory system tracks the physical location of the pages.

The effective size of a page is the number of virtual addresses to which the addresses in the page are mapped. In conventional virtual memory systems, the size of a page is the same at its effective size.

The virtual memory system is often implemented in multiple levels, or together with other address translation mechanisms. For example, the Intel 80386 microprocessor implements a two level page-translation mechanism, with support for page-directories and page-tables. The Intel 80386 microprocessor also supports a segmentation mechanism in addition to a paging mechanism.

Existing virtual memory systems suffer from a number of disadvantages. In particular, the framework provided for mapping physical memory to virtual address spaces is inflexible, as discussed below.
1. The size of a page needs to be selected from a small number of possible page-sizes. It is not possible for a page to be of an arbitrary size. It is not possible for a page to be of a size that is not a power of two.
2. The physical address of a page is required to be aligned at fixed boundaries. The physical address of a page is required to be a multiple of the size of the page. It is not possible for the physical address of a page to be aligned at other, or arbitrarily selected, boundaries.
3. Some virtual memory systems support a number of page sizes, from among the possible page-sizes. In some cases, two or more pages are combined to form larger pages, in accordance with fixed rules, if they are contiguous in the physical address space as well as in the virtual address space. In general, however, it is not possible, practical, or advantageous, to combine the use of pages with arbitrary sizes in a single virtual address space.
4. A page must be mapped at fixed boundaries in the virtual address space. Such virtual address is required to be a multiple of the size of the page. It is not possible to map a page at other, or arbitrarily selected, virtual addresses. It is not possible to re-map a page previously mapped at a virtual address to a higher or lower virtual address, where the new virtual address is not aligned at such fixed boundaries.
5. The entire page is mapped to the virtual address space. It is not possible to maintain unused, spare, or unmapped space in a page. The effective size of a page is required to be equal to the size of the page.
6. The page-offset part of the virtual address is not translated, but is used without modification as the page-offset in the page. The page-offset does not otherwise participate in the translation or mapping process.
7. A page-table-entry maps an entire page to the virtual address space. It is not possible to map a part of a page using a page-table-entry. It is not meaningful for more than one page-table-entry to map to the same page, or parts of the same page.
8. Fine-grained protection and access-control are not provided. Protection and access-control are limited to fixed-sized pages, as described above. However, in practice, it is not possible to ensure that a logical unit of data requiring control should exactly fit in one or more fixed-sized pages.
9. Methods for creating and managing memory-mapped functions or procedures are not provided.
10. Methods for creating and managing memory-mapped virtual lookup-tables are not provided. In programming, it is often desirable to provide the result of some computations as lookup tables. For example, a virtual lookup table may provide square roots of natural numbers. Ideally, when an entry in such a lookup-table is first accessed at a virtual address, a user-defined function may be invoked to compute the relevant value at such location. Such value may be placed in a small page, which may then be mapped to the virtual address space. However, in existing virtual memory systems, the page size is required to be quite large, and square roots of several numbers in addition to the desired result would be required to be computed. This makes virtual lookup-tables impracticable.
11. Methods for relocation, insertion, or removal of arbitrary amounts of data in a virtual memory-region, which may be performed without large-scale copying of existing data, are not provided.
12. Methods for optimizing the use of limited page-table-entries present in a translation lookaside buffer are inadequate.

Hence there exists a need for a more flexible and efficient method of mapping physical memory to a virtual address space.

### Objects of the Invention

Several objects of the present invention are to provide a virtual memory system, wherein
1. Pages with unequal sizes or unequal effective sizes are mapped to a contiguous virtual address-space.
2. The effective size of a page (i.e., the number of virtual addresses to which addresses in a page are mapped), is not required to be equal to the size of the page. The effective size of a page may change from time to time.
3. The sizes, or the effective sizes, of the pages are not required to be fixed, but may vary from page to page, and can be of any convenient size. The size or effective size of a page is not dependent on any page-frame-size.
4. A page possesses unused, unmapped, or spare space. The unused, unmapped, or spare space in a page may change from time to time. It is not necessary for the pages to store data equal to the page-size, but may have unused space, and thereby storing unequal amount of data.
5. The physical address of a page is not required to be aligned at fixed boundaries. The virtual address to which a page is mapped is not required to be aligned at fixed boundaries.
6. A page-table-entry can map two or more pages, or parts of two or more pages, to the virtual address space. A number of page-table entries map to a page, or parts of a page.
7. Fine-grained access-control and protection to any parts of the virtual memory region is provided. Access control and protection is provided over pages of variable or unequal sizes. Moreover, access control and protection may be provided over part of a page.
8. Method is provided for relocation, insertion, and removal of arbitrary amounts of data in a virtual memory region, whose operation does not require large-scale copying of data in physical memory.
9. Method is provided for creating and managing efficient memory-mapped functions and procedures. Method is also provided for creating and managing efficient virtual lookup tables. The operation of the virtual lookup table provided does not require computation of values for lookup-table-entries other than the one that is desired.
10. Method for optimizing the use of limited number of page-table-entries in a translation lookaside buffer are provided.

Further objects and advantages will become apparent from a consideration of the ensuing description and drawings.

### SUMMARY

In accordance with the present invention, apparatus and methods are provided for creating a virtual memory system that maps variable-sized or unequal-sized pages. The present invention maps pages of varying sizes to the virtual address space. Accordingly, while using the invention, the amount of data stored in a page may vary from page to page.

### DRAWINGS

FIG. 1 shows a schematic diagram of a memory management unit 101 of the present invention.

FIG. 2A shows a virtual address space.

FIG. 2B shows a physical address space.

FIG. 3 shows a virtual address.

FIG. 4 shows the structure of a page-table.

FIG. 5 shows the structure of a page-table-entry.

FIG. 6 shows the structure of a mapping entry.

FIG. 7 shows the working of a translation-descriptor selection module.

FIG. 8 shows the working of an address computation module.

FIG. 9 shows a schematic diagram of the mapping of variable-sized pages to a virtual address space.

FIG. 11 shows a schematic diagram of the memory management unit 1101 of the present invention.

FIG. 12 shows a translation lookaside buffer.

FIG. 21 shows a schematic diagram of the memory management unit 2101 of the present invention.

FIG. 22 shows a translation lookaside buffer 2201.

FIG. 31 shows a virtual memory region 3101 of the present invention.

FIG. 32A shows a variable-sized page 3201.

FIG. 32B shows a variable-sized page 3202.

FIG. 33 shows a page-database 3301.

FIG. 34 shows the mapping of a number of pages 3201 and 3202 to virtual address space 201.

FIG. 38A shows an exemplary memory region 3801.

FIG. 38B shows the exemplary memory region 3801 after relocation of some existing data, and insertion of new data.

FIG. 41 shows a schematic diagram of virtual memory region 4101.

FIG. 51 shows a schematic diagram of virtual lookup table 5101.

### DETAILED DESCRIPTION OF THE INVENTION

The present invention is described below with reference to a preferred embodiment and the accompanying drawings. However, the said drawings only illustrate the invention and in no way limit the same.

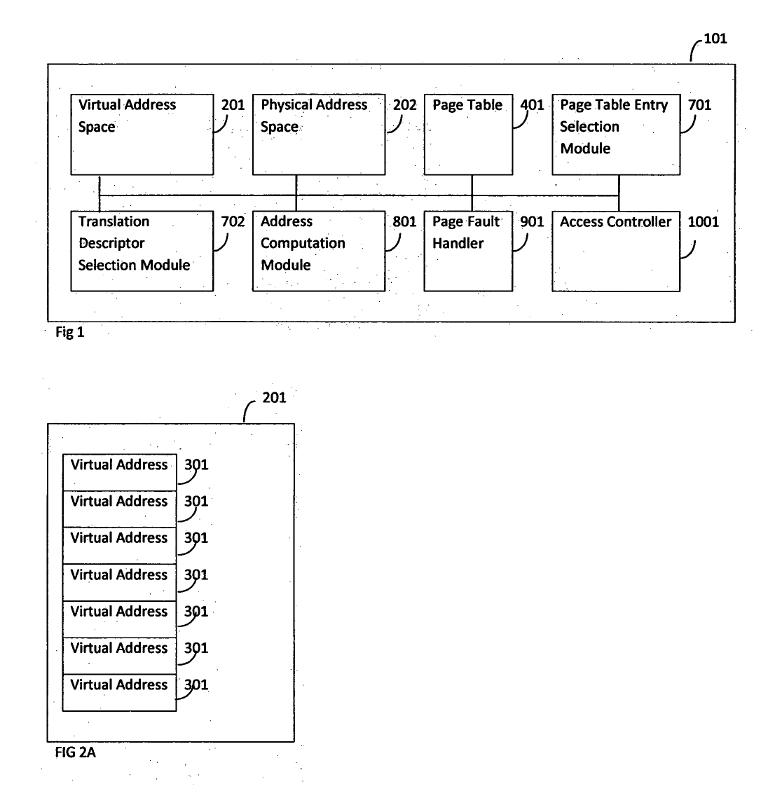

FIG. 1 shows a schematic diagram of the preferred embodiment of the invention. Accordingly, memory management unit 101 comprises a virtual address space 201, a physical address space 202, page-table 401, page-table-entry selection module 701, translation-descriptor selection module 702, address computation module 801, page-fault handler 901, and access-controller 1001.

FIG. 2A shows a virtual address space. The virtual address space 201 comprises a number of virtual addresses.

FIG. 2B shows a physical address space. The physical address space 202 comprises a number of pages 203. Each page 203 comprises a number of physical addresses.

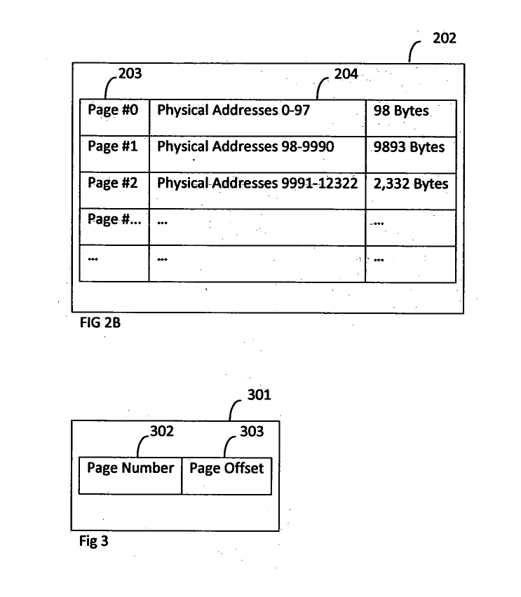

FIG. 3 shows virtual address 301. The virtual address is split into a page-number 302 and a page-offset 303.

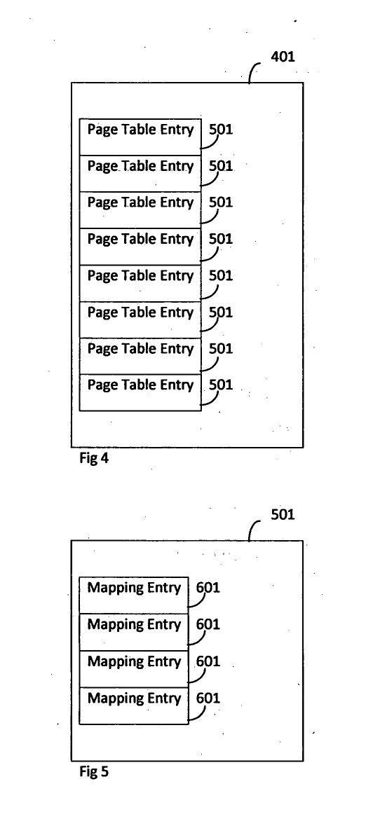

FIG. 4 shows page-table 401. The page-table comprises a number of page-table-entries 501.

FIG. 5 shows page-table-entry 501. A page-table entry comprises one or more mapping entries 601.

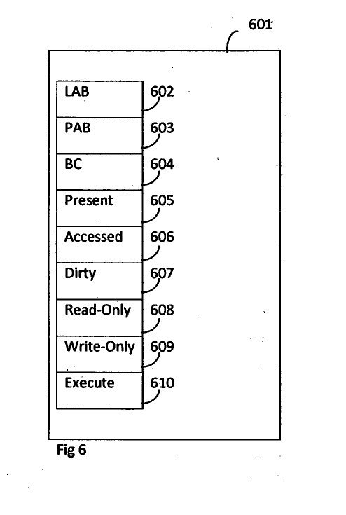

FIG. 6 shows mapping-entry 601. A mapping entry is a translation descriptor, and comprises virtual address to physical address mappings, as described hereunder. A mapping entry comprises an LAB field 602, a PAB field 603, a BC field 604, a present-bit field 605, an accessed-bit field 606, a dirty-bit field 607, a read-only bit-field 608, a write-only bit-field 609, and an execute bit-field 610.

The LAB field holds a virtual address. The PAB field holds a physical address. The BC field holds a count of bytes. The mapping entry maps a number of virtual addresses to the same number of physical addresses. The LAB and the PAB hold complete addresses, without truncating the lower bits.

Page-table-entry selection module 701 selects a page-table-entry by using the page-number 302 of the received virtual address as in index in the page table.

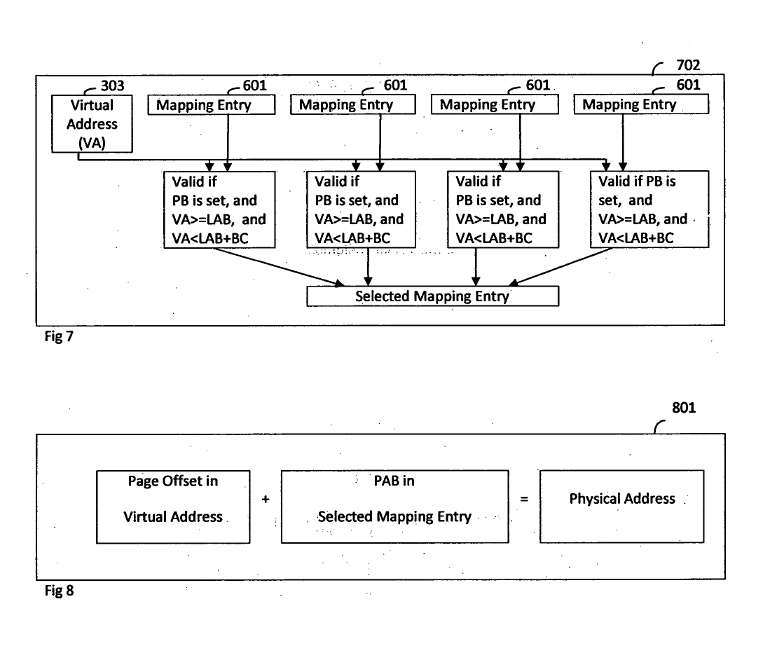

FIG. 7 shows Translation-descriptor selection module 702. The translation-descriptor selection module 702 attempts to select a suitable mapping-entry in the selected page-table-entry. A mapping entry is considered suitable to be selected if the present-bit field is set, and the virtual address is greater than or equal to the LAB value, and the virtual address is less than the sum of the LAB and BC values.

FIG. 8 shows the working of address computation module 801. Address computation module 801 computes the physical address for a given virtual address by adding the PAB value of the selected mapping entry and the page offset 303.

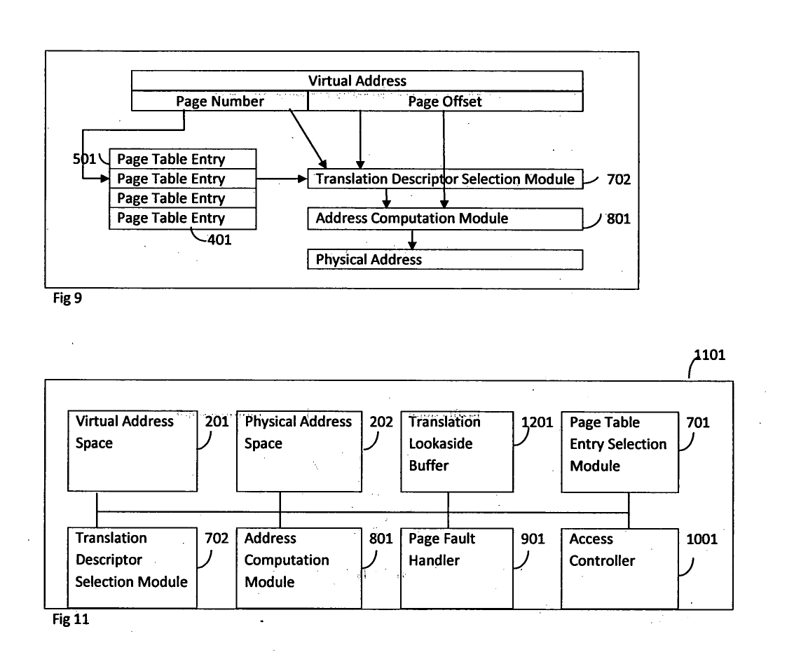

FIG. 9 shows the working of the memory management unit 101. During data access using a virtual address, the page selection module selects a page-table-entry; the translation-descriptor selection module selects a mapping entry in the selected page-table-entry. The address computation module computes the physical address as described above. The system accesses the data at the physical address so computed.

However, if a suitable page-table-entry or a suitable mapping entry could not be selected, a page-fault is raised. Page-fault handler 901 handles the page-fault. The page-fault-handler prepares an appropriate page, and inserts an appropriate mapping entry in the page-table-entry. The page-fault handler then returns control to the system; and the memory-access operation is re-started.

The memory management unit sets the accessed bit field in a mapping-entry when the memory region mapped by the mapping entry is accessed. The memory management unit sets the dirty-bit field when the memory is accessed for writing. The accessed-bit and dirty-bit fields in the mapping entry are used to implement a replacement policy.

Access-controller 1001 is configured to implement a memory-protection and control policy. The access-controller sets the read-only, write-only and execute bit-fields in the mapping entries, as required, to provide the desired access-control as described hereunder. If the read-only bit field in a mapping entry is set, the memory management unit raises an exception or fault when an attempt is made to modify data in the memory region mapped by the mapping entry. If the write-only bit field is set, the memory management unit raises an exception or fault when an attempt to read data in the memory region mapped by the mapping entry. If the execute-bit field is not set, the memory management unit raises an exception or fault when an attempt is made to execute data in the memory region mapped by the mapping entry. These exceptions or faults may be handled by appropriate handlers.

The number of bytes mapped by a mapping entry is not fixed, but may vary as required. The number of bytes mapped by a mapping entry is not required to be a multiple of one or more specific page-sizes. The number of bytes mapped is not required to be a multiple of two, or a power of two. The starting and ending virtual addresses mapped by a mapping entry are not required to be aligned at any specific boundaries in the virtual address space, but may vary as required. The starting and ending physical addresses-mapped by a mapping entry are not required to be aligned at any specific boundaries in the physical address space, but may vary as required.

A mapping entry thus maps the whole or part of a page to the virtual address space. A number of regions in a page may be mapped to the virtual address space using one or more mapping entries, in one or more page-table-entries.

As the mapping entry is capable of mapping arbitrary amounts of data in a page to the virtual address space, the page may hold unused, spare, or unmapped space. Such spare space may be mapped to the virtual address space at a later time, and may be used for insertion and removal of data, as described later.

As may be seen, the virtual memory system is capable of mapping a number of pages of arbitrary sizes, or arbitrary effective sizes, in a virtual address space. The size and the effective size of a page are not fixed, and are not required to be equal. The size and the effective size of a page in a virtual memory region are not required to be equal to the size and the effective size respectively of another page in the virtual memory region. The physical address of a page is not required to be aligned at fixed boundaries. The virtual address at which the first address in a page is mapped is not required to be aligned at fixed boundaries.

FIG. 11 shows a schematic diagram of an alternative preferred embodiment of the invention. Accordingly, the memory management unit 1101 comprises a virtual address space 201, a physical address space 202, translation lookaside buffer 1201, page-table-entries 501, mapping entries 601, page-table-entry selection module 701, translation-descriptor selection module 702, address computation module 801, page-fault handler 901, and access-controller 1001.

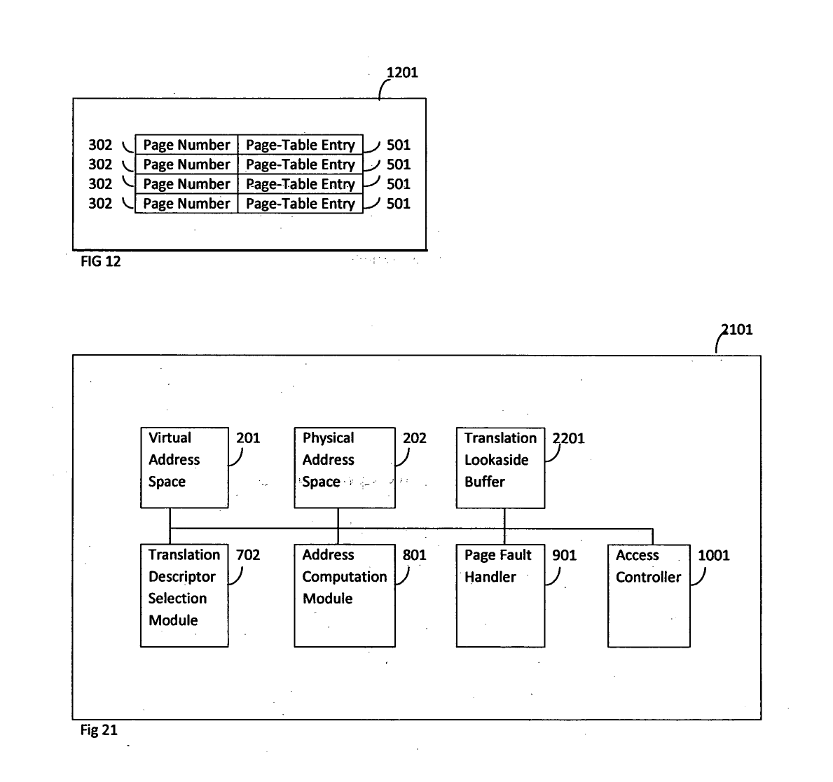

FIG. 12 shows a translation lookaside buffer 1201. The translation lookaside buffer comprises one or more page-table-entries 501. Each page-table-entry in the translation lookaside buffer is associated with a page-number.

When accessing a virtual memory address, the selection module uses the page-number to select a page-table-entry in the translation lookaside buffer. If a suitable page-table-entry is selected, it attempts to select a suitable mapping-entry in the selected page-table-entry, as previously described. The address computation module computes the physical address, as previously described. The system can now access the data at the physical address so computed.

The memory management unit generates a page-fault if a suitable page-table-entry or a suitable mapping entry could not be selected. Page-fault handler software 901 handles the page-fault. The page-fault handler prepares a physical memory region or page, inserts a mapping entry in a page-table-entry in the translation lookaside buffer, and returns control to the system.

The other components of the embodiment are already described previously.

FIG. 21 shows a schematic diagram of an alternative preferred embodiment of the invention. Accordingly, the memory management unit 2101 comprises a virtual address space 201, a physical address space 202, a translation lookaside buffer 2201, a page-table-entry 501, mapping entries 601, translation descriptor selection module 702, address computation module 801, page-fault handler 901, and access-controller 1001.

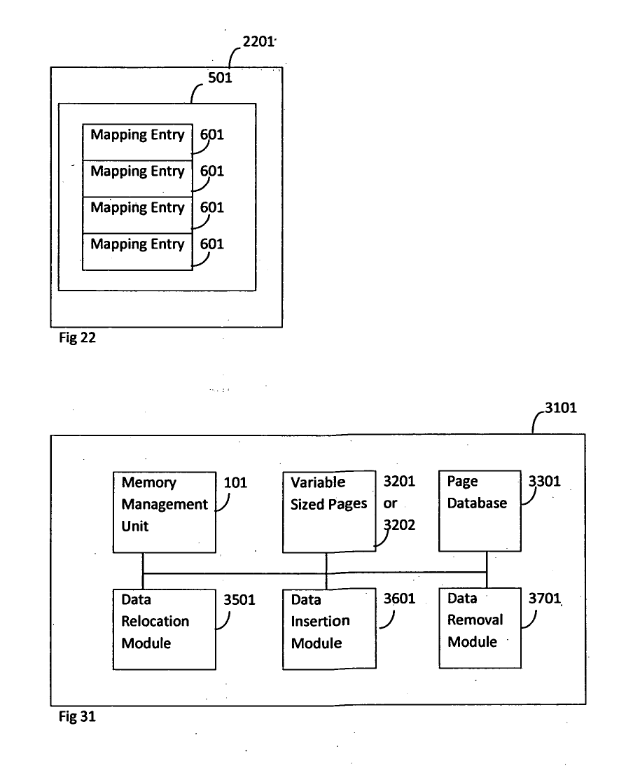

FIG. 22 shows translation lookaside buffer 2201. The translation lookaside buffer comprises a single page-table-entry 501. The page-table-entry 501 comprises one or more mapping entries 601.

In this embodiment, the virtual address is not split into a page-number and page-offset. The entire virtual address is treated as a page-offset. When accessing a memory location at a virtual address, the translation-descriptor selection module 702 attempts to select a suitable mapping entry from among the mapping entries in the page-table-entry 501, as previously described. The address computation module computes the physical address, as previously described. The system can now access the data at the physical address so derived.

The memory management unit generates a page-fault if a suitable mapping-entry could not be selected. Page-fault handler software 901 handles the page-fault. The page-fault handler prepares a relevant physical memory region or page, inserts an appropriate mapping entry in the page-table-entry in the translation lookaside buffer, and returns control to the system.

FIG. 31 shows an alternative embodiment of the invention. Accordingly, virtual memory region 3101 comprises memory management unit 101, variable-sized pages 3201 or 3202, a page database 3301, data relocation module 3501, data insertion module 3601, and data removal module 3701.

FIG. 32A shows a variable sized page 3201 with a size of n bytes. The value of n may vary from page to page.

FIG. 32B shows a page 3202 with a capacity 1024 bytes, with unused or spare space of 91 bytes, and an effective size of 933 bytes; i.e., only 933 bytes of this page are mapped to the virtual address space. The effective size of the page, and the amount of unused space in the page, may vary from page to page, and from time to time.

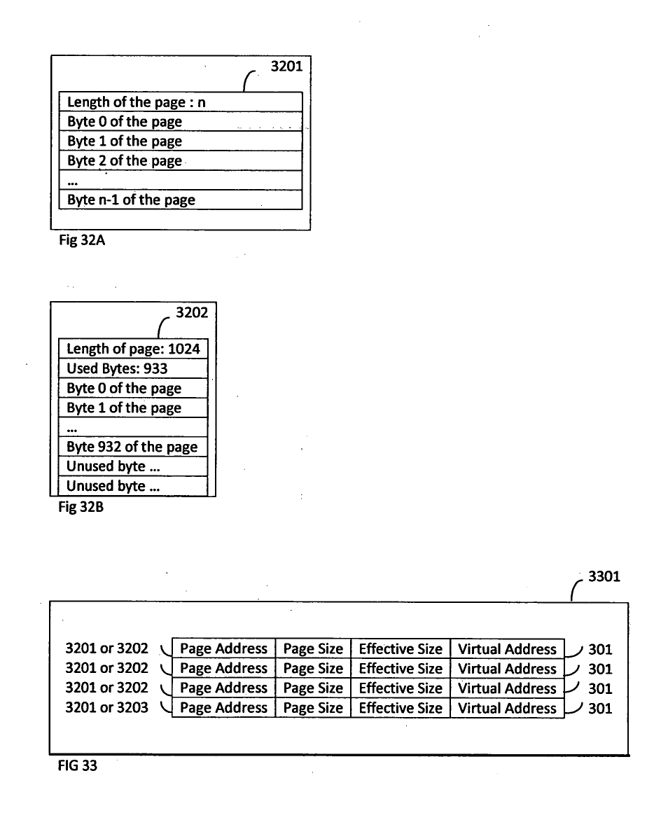

FIG. 33 shows a page database 3301. The page-database comprises a number of pages 3201 or 3202. The page-database keeps track of the pages and their virtual addresses, size and effective size of each page in the virtual memory region. The virtual address, size, and effective size of a page may vary from time to time.

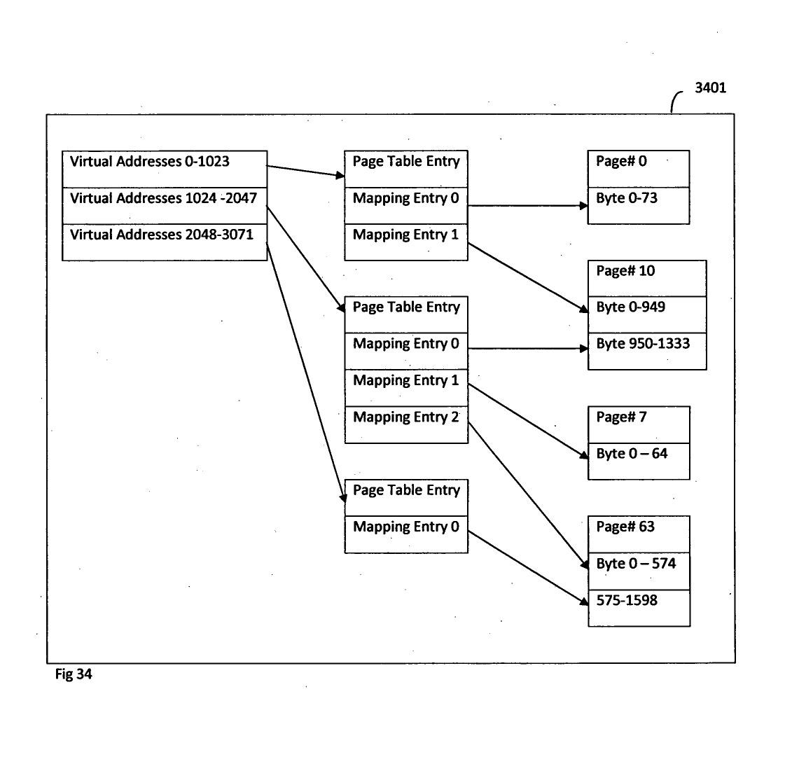

FIG. 34 shows a schematic diagram of the mapping of a number of pages 3201 and 3202 in the page-database to virtual address space 201 using page-table 401 in the memory management unit 101 or 1101. One or more mapping entries 601 in one or more page-table-entries 501 in the page table 401 map addresses in each variable-sized page to the virtual address space.

Data relocation module 3501 relocates one or more data elements in the virtual memory region to higher or lower virtual addresses. The data relocation module relocates data by dissociating one or more pages in the page-directory from their virtual addresses, and associating such pages with new virtual addresses. Thus, the data re-location module relocates data in a memory region to higher or lower addresses without physically copying such data.

Data insertion module 3601 inserts one or more data elements in the virtual memory region. The data insertion module uses data relocation module to relocate one or more existing data elements to new virtual addresses. The data insertion module is also configured to insert new pages in the page-database, and to associate the new pages to virtual addresses. The data insertion module is also configured to insert additional data elements in a page with spare capacity.

Data removal module 3701 removes one or more data elements in the virtual memory region. The data removal module is configured to remove one or more existing data elements in a page, thereby increasing its spare capacity. The data removal module is also configured to dissociate one or more data elements from the virtual addresses at which they are mapped. The data removal module is also configured to remove one or more pages in the page-database. Further, data removal module uses the data relocation module to relocate one or more data elements to new virtual addresses.

The data relocation module, the data insertion module and the data removal module are configured to relocate, insert, and remove data in the virtual memory region by performing one or more of the following operations:
1. Inserting one or more new pages in the page-database.
2. Removing one or more existing pages in the page-database.
3. Replacing a page in the database with another page.
4. Re-arranging the order of the pages in the page-database.
5. Increasing the size of one or more pages in the page-database.
6. Reducing the size of one or more pages in the page-database.
7. Re-associating one or more pages in the page-database to higher addresses in the virtual address space.
8. Re-associating one or more pages in the page-database to lower addresses in the virtual address space.
9. Inserting new data into an existing page by using unused space in such page, and increasing the effective size of the page.
10. Removing existing data from a page in the page-database, and increasing unused space in such page, and reducing the effective size of the page.
11. Re-mapping or invalidating existing mappings, by modifying one or more mapping entries in the page-table or the translation-lookaside buffer.

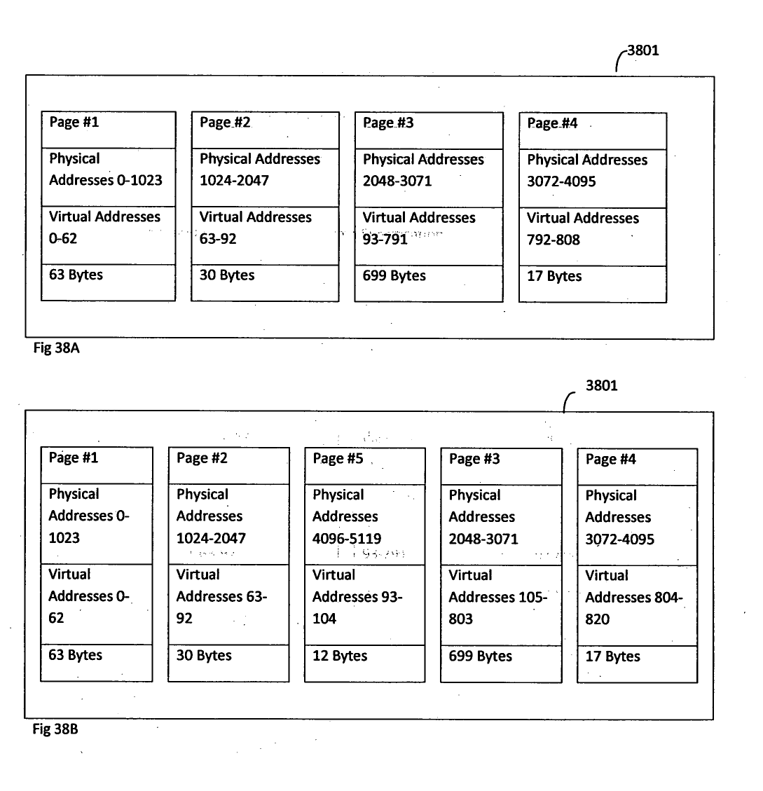

FIGS. 38A and 38B show the method of relocation and insertion of data in a memory region. The method of removal of data is the reverse of the method of insertion.

FIG. 38A shows a number of variable sized pages comprised in an exemplary virtual memory region 3801. Accordingly, pages #1, #2, #3, and #4 are mapped at virtual addresses 0, 63, 93, and 792. Further, pages #1, #2, #3, and #4 map 63, 30, 699, and 17 bytes respectively to the virtual address space. The total size of the virtual memory region is 809 bytes.

FIG. 38B shows the pages comprised in virtual memory region 3801 after relocation of some existing data, and insertion of new data. Accordingly, pages #3 and #4 are mapped at addresses [symbol] 5 and 804 respectively. Page #5 is inserted into the memory region and is mapped at address [symbol] . Pages #1 and #2 remain unchanged. The number of bytes mapped by page #5 in the virtual address space is 12. The new size of the virtual memory region is 821 bytes.

In this manner, a number of bytes in pages #3 and #4 are relocated to higher addresses in the memory region without physically copying the data in the pages, and a number of bytes in page [symbol] are inserted into the memory region.

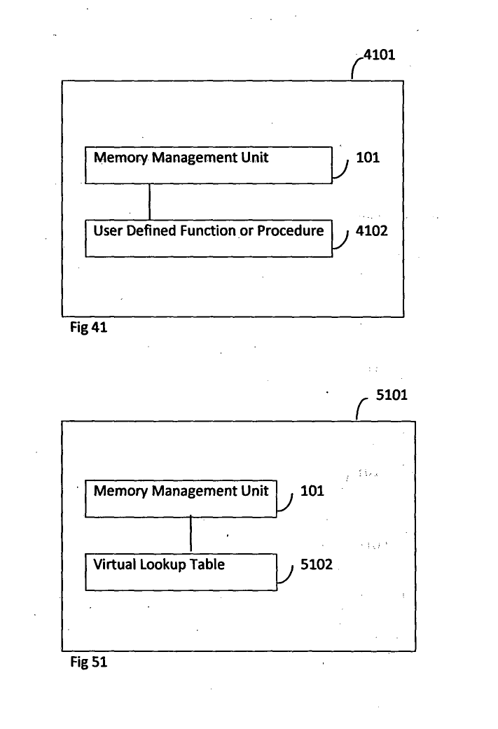

FIG. 41 shows an alternative embodiment of the invention. Accordingly, virtual memory region [symbol] 01 comprises a memory management unit 101, and a user-defined function 4102.

User-defined function 4102 is configured by the system, by the programmer, or by a user, to perform an operation and/or to provide a value.

When a virtual address in the virtual memory region is accessed, a page-fault is generated. The page-fault handler invokes the user-defined function 4102. The user-defined function is provided with the virtual address as an input parameter, based upon which it performs the configured operations and/or computes a value. The value is stored in a small page. The page-fault handler maps the page at the virtual address using one or more mapping entries. The computed value is now accessible at the virtual address

FIG. 51 shows an alternative embodiment of the invention. Accordingly, virtual lookup-table 5101 comprises virtual memory region 4101, and a number of virtual-table entries 5102. One or more virtual addresses in the virtual memory region represent a virtual table entry. All the virtual table entries in the virtual memory region together represent the virtual lookup table.

When an entry in a virtual-lookup table is accessed, a page-fault is generated. The page-fault handler invokes the user-defined function 4102. The user-defined function computes a value. This computed value is stored in a small page, which is then be mapped at the appropriate virtual address. As such, it is not necessary to compute values for entries other than the entry accessed, in the virtual lookup-table.

The entries in the lookup table can also be provided protection by setting the read-only bit field in the mapping entries. However, if read-only protection is not used, the entries in the lookup table may be modified using virtual addresses. Any such modifications may be used in subsequent operations as input to the user-defined function. The user defined function may also use values stored in other virtual lookup tables or virtual memory regions.

### Advantages of the Invention

In addition to the advantages described above, the invention provides many other advantages. For example, the invention simplifies the structure and usage of many data-structures, thereby improving the efficiency of computers. The invention is useful to create a virtual memory region using a number of network packets of varying sizes. The invention is also useful for creating memory-regions with holes of arbitrary sizes.

### Scope of Invention

The present invention may be implemented using page-tables or translation lookaside buffers, or any other suitable mechanism. The present invention may also be implemented in multiple levels, so that the physical address of one level is the virtual address of another. The page translation mechanism may be extended by including support for page-directories, segmentation etc.

Several variations of the structure of a mapping entry can reduce the size of the page-table-entries or the TLB entries. For instance, the LAB field may be truncated by removing some of its upper bits, since the value of such bits are implied by the page-number. In case of page-table-entry with two mapping entries, the LAB of the second mapping entry is not required as such value can be easily derived from the preceding entry's LAB+BC. Further, a number of lower bits in the second mapping entry's PAB can be eliminated as their value can be guaranteed to be zero under appropriate conditions.

The preferred embodiments show memory mapping granularity of one byte. It is possible to modify the granularity of the mapping process using other data types such as bits, words, double-words, or other record-types.

The invention can be used so that a multitude of pages may be mapped using a single page-table-entry, or to a single page-frame. The page-table-entry can also be so used that a single page may be mapped using a multitude of page-table-entries, or to multiple page-frames. Further, it is not necessary to map all addresses within a page-frame at the same time, and the page-table-entry can be used to map only a part of the page-frame to physical memory.

The invention also includes a computer or other electronic device incorporating one or more of the aforesaid features.

While the above description contains many specificities, these should not be construed as limitations on the scope of the invention, but rather as an exemplification of the preferred embodiments thereof. Many other variations are possible.

1. A memory management unit for providing a virtual memory region, comprising
a. a plurality of virtual addresses in a virtual address space, the plurality of virtual addresses including one or more blocks of virtual addresses;
b. a plurality of pages, each page comprising one or more blocks of physical addresses; and
c. a device for associating the plurality of physical addresses with the plurality of virtual addresses, by associating the blocks of physical addresses with the blocks of virtual addresses;
wherein the size of at least one block of physical addresses is greater than the size of another block of physical addresses, and the size of the block of physical addresses is not a multiple of the size of the other block of physical addresses, the size of a block being the number of addresses in the block.

2. The memory management unit of claim 1, wherein
a. the size of at least one block of physical addresses is a number that is not a power of two; or
b. the size of at least one page is a number that is not a power of two.

3. The memory management unit of claim 1, wherein a first virtual address in at least one block of virtual addresses a. is a number that is not a power of two; or b. is not a multiple of the size of the said block of virtual addresses.

4. The memory management unit of claim 1, wherein a first physical address in a block of physical addresses in a page
a. is a number that is not a power of two; or
b. is not a multiple of the size of said block of physical addresses; or
c. is not a multiple of the size of said page.

5. The memory management unit of claim 1, wherein values of bits included in a page-offset in at least one physical address are not equal to the values of corresponding bits in an associated virtual address.

6. The memory management unit of claim 1, wherein one or more pages have spare capacity.

7. The memory management unit of claim 1, further comprising
a. a plurality of data elements stored at a plurality of virtual addresses; and
b. at least one of
i. a data relocation module configured to relocate one or more data elements from an existing set of virtual addresses to another set of virtual addresses, by dissociating physical addresses of the data elements from the existing set of virtual addresses, and re-associating the physical addresses with the other set of virtual addresses;
ii. a data insertion module, configured to insert one or more additional data elements in the virtual memory region, by associating one or more additional physical addresses to the virtual addresses; and
iii. a data removal module, configured to remove one or more data elements in the virtual memory region, by disassociating one or more physical addresses from the virtual addresses.

8. The memory management unit of claim 7, wherein
a. the number of data elements relocated is a number that is not a power of two; or
b. the difference between the existing virtual address and the new virtual address of a relocated data elements is a number that is not a power of two; or
c. the number of data elements inserted is a number that is not a power of two; or
d. the number of data elements removed is a number that is not a power of two.

9. A method for providing a virtual memory region, by
a. providing a plurality of virtual addresses in a virtual address space, the plurality of virtual addresses including one or more blocks of virtual addresses;
b. providing a plurality of blocks of physical addresses in a number of pages; and
c. associating physical addresses with the virtual addresses, by associating the blocks of physical addresses with the blocks of virtual addresses;
wherein the size of at least one block of physical addresses is greater than the size of another block of physical addresses, and the size of the block of physical addresses is not a multiple of the size of the other block of physical addresses; the size of a block being the number of addresses in the block.

10. The method of claim 9, wherein
a. the size of at least one block of physical addresses is not a number that is a power of two; or
b. the size of at least one page is not a number that is a power of two.

11. The method of claim 9, wherein a first virtual address in the at least one block of virtual addresses associated with the block of physical addresses in a page
a. is a number that is not a power of two; or
b. is not a multiple of the size of the said block of virtual addresses; or
c. is not a multiple of the size of the said page.

12. The method of claim 9, wherein a first physical address in the block of physical addresses in a page
a. is a number that is not a power of two; or
b. is not a multiple of the size of the block of physical addresses; or
c. is not a multiple of the size of said page.

13. The method of claim 9, wherein values of bits comprised in a page-offset in the at least one physical address are not equal to values of corresponding bits in the associated virtual address.

14. The method of claim 9, wherein one or more pages have spare capacity.

15. The method of claim 9, further comprising
a. storing a plurality of data elements at a number of virtual addresses; and
b. at least one of
i. relocating one or more of the data elements from an existing set of virtual addresses to another set of virtual addresses, by dissociating the physical addresses of the data elements from said existing set of virtual addresses, and re-associating the physical addresses with the other set of virtual addresses;
ii. inserting one or more additional data elements in the virtual memory region, by associating one or more additional physical addresses to virtual addresses; and
iii. removing one or more data elements in the virtual memory region, by disassociating one or more physical addresses from virtual addresses.

16. The method of claim 15, wherein
a. the number of data elements relocated is a number that is not a power of two; or
b. the difference between the existing virtual address and the new virtual address of a relocated data elements is a number that is not a power of two; or
c. the number of data elements inserted is a number that is not a power of two; or
d. the number of data elements removed is a number that is not a power of two.

17-54. (canceled)
